(19) United States
(12) Patent Application Publication
(10) Pub. No.: US 2012/0045552 A1
(43) Pub. Date: Feb. 23, 2012

(54) INTERMEDIATE FOOD PRODUCT

(75) Inventors: Gerhard F. Fox, Neuenburg (DE); Winfried Koch, Berlin (DE)

(73) Assignee: HERBSTREITH & FOX KG, Neuenburg (DE)

(21) Appl. No.: 13/266,121

(22) PCT Filed: Apr. 20, 2010
(86) PCT No.: PCT/EP2010/002398

§ 371 Date: Oct. 24, 2011

(30) Foreign Application Priority Data
Apr. 23, 2009 (DE) 10 2009 018 367.1

(51) Int. Cl. A23L 1/308; B65B 55/02; A23P 1/00

(52) U.S. Cl. 426/87; 426/648; 426/232

(57) ABSTRACT

An intermediate food product for the production of a fiber-enriched food end product by mixing and further processing it with a liquid-containing end product addition comprises dietary fibers made of insoluble fruit and/or vegetable fibers that are mixed with a base liquid. For this purpose, the intermediate food product is preportioned and packaged in a packaging that can be transported, stating an amount of the end product addition to be used which ensures a dietary fiber portion of at least 3.0 wt-% of the food end product. The dietary fibers and the base liquid are pretreated by applying shearing forces and have a paste-like consistency.

The invention relates to an intermediate food product as defined in the preamble to claim 1 which is used for producing fiber-enriched food end products, in particular used in canteens or commercial kitchens. The intermediate food product is provided to be mixed and further processed, in particular with a liquid-containing end product addition, for example consisting only of water, or oil, or with other ingredients for producing sauces, or vegetable and meat dishes such as goulash, or sweets and desserts in the form of ice cream or sorbets. The intermediate food product contains plant fiber material which can be mixed with a base liquid that essentially consists of oil and/or water. The dietary fiber material advantageously consists of soluble and/or insoluble plant fibers, such as fruit or vegetable fibers, wherein primarily insoluble plant fibers are provided. The plant fibers can consist of insoluble citrus and/or apple fibers, or of soluble plant fibers such as inulin or pectin, or a combination thereof, wherein this ensures a particularly high hydration capacity of the intermediate food product. The invention furthermore relates to the production of the intermediate food product.

The document EP 0 835 614 B1 discloses a food item used as sauce additive which comprises an oil-in-water emulsion. This additive furthermore contains vegetable or fruit powder in a fibrous form, wherein the fibers are not completely soluble in water. The food should furthermore preferably contain a share of starch of 5 to 30 weight %.

The document DE 42 26 245 A1 describes a fiber-enriched beverage which contains cereal or grain fibers. To ensure an acceptable flavor with respect to the grain fibers, these must be treated with enzymes.

The document EP 1 458 244 B1 describes a kit for instantly producing a spreadable emulsion containing water and oil. The kit contains a separately packaged oil phase which comprises a cold-hydrating thickening agent. Provided as additional or alternative material to the cold hydrating thickening agent are insoluble plant fibers marketed under the brand “Herbacel AQ Plus.”

The document U.S. Pat. No. 6,455,090 describes a thickening agent for which two pre-portioned liquids are used. The thickening agent constitutes less than 5.0 weight % of a first liquid which, together with a calcium lactate containing second liquid, is mixed into water. With a share of the first liquid of 20%, the total product thus has a gel-type consistency.

The document EP 1 728 439 A1 describes a food system with a binder component and a flavor component, wherein the binder component contains a filler material, for example pectin.

The document US 2004/0197456 describes a watery thickening concentrate which contains a soluble share of dietary fibers ranging from 4 to 10%.

The document US 2003/0017219 A1 describes a watery intermediate food product containing soluble dietary fibers, by means of which the blood-sugar values can be stabilized when consuming a soft drink.

The company publication “Pectins in Preventive Nutrition and Therapy” of the Herbstreith & Fox Corporate Group, issued on the occasion of the “Vitafoo Congess”¹ in 1997 (E7) describes a beverage with a fiber content of 3% which is produced with the aid of a low-viscous, ready to consume pectin solution. ¹ Note: Vitafoo Congress should be Vitafood Congress

With the increasing health consciousness of the consumers, the demand has noticeably increased for products which are low in calorie and high in dietary fiber. The same is true for the areas of catering and community meals, for example in hospitals or nursing homes and in the food service industry. In particular in the field jointly referred to as providing meals outside of the home, sauces are considered calorie-rich products which can be improved considerably with respect to energy density. With respect to low-calorie sauces and sweet desserts offered in particular in the aforementioned area, on the other hand, consumers have shown a low acceptance of products which have lost flavor or texture.

It is the object of the invention to avoid the aforementioned disadvantages for a generic intermediate food product and to permit an easy production of improved food end products, in particular in the area of meals outside of the home or catered meals.

This object is solved with an intermediate food product having the characteristics as disclosed in claim 1. The intermediate food product in this case is pre-portioned, listing an amount of the end product to be added which ensures a dietary fiber share of at least 3.0 weight % of the food end product, and is packaged so as to be tightly sealed in a package that can be transported. According to one especially advantageous embodiment, the dietary fiber materials and the base liquid are pre-treated by applying shearing forces. In this way, the swelling capacity of the dietary fiber materials can be increased and a paste-like consistency achieved which, in turn, permits a smooth texture of the food end product to be produced. As a result, a positive flavor is created inside the mouth during the consumption of the food. Sauces can furthermore be produced with the intermediate food product where such end product admixtures as meat or vegetable pieces are kept suspended. The stirring or scooping of the dishes, in particular relating to bulk foods used for community meals, can thus be made much easier. The sauces can furthermore absorb precipitated out protein, to a degree which is not visible to the consumer.

As a result, the intermediate food product can be made available in a form where it is ready-for-use, as well as easy to store or transport. The intermediate food product is furthermore not sensitive to standard storage and processing temperatures and can be stored, for example, without problem in the frozen state.

Following the storage and transport to the respective processing location, for example a commercial kitchen, the intermediate food product must only be mixed at the predetermined ratios with the respective end product admixtures and processed further to obtain the desired food end products, wherein the processing can occur without problem even at extremely high temperatures. The resulting food end products, for example sauces, have an especially low tendency to scorch and, following the production, can be removed especially easily from the devices and utensils that are used.

Owing to the guaranteed minimum dietary fiber content of 3.0 weight %, a dietary fiber-enriched food end product is furthermore obtained which on the one hand satisfies the need for a healthy and calorie-reduced product and, on the other hand, has a good flavor and convenient texture. The intermediate food product for the most part has a neutral flavor, so that it can be used to produce a large variety of food end products with very different flavors. In addition, an intermediate food product of this type has a low pH value which ensures on the one hand a longer shelf life and, on the other hand, permits the processing over a very wide pH spectrum. For example, the intermediate food product also allows the non-standard use of whipping cream or other cream-containing products together with vinegar and other acid-containing products for the preparation of a food end product.

It is furthermore advantageous if the dietary fiber materials and the base liquid are additionally mixed with a flavor base. A particularly easy and convenient further processing of the intermediate food product into a food end product is thus possible. For example, the intermediate food product can be prepared as a type of ready meal which need only be mixed with water to obtain a food end product that can be served.

It is furthermore advantageous if the flavor base contains salt, sugar, sweetener, seasonings, aromatic agents, vegetable components, meat extracts and/or additional soluble dietary fibers such as pectin or inulin. In this way, a large variety of food end products having the desired consistency can be produced in a commercial kitchen.

The share of the starch preferably amounts to less than 1.5 weight %, thereby resulting in a clear reduction of the calorie content.

It is also advantageous if the dietary fiber materials and the base liquid are reheated inside the packaging, thereby achieving a shelf life or durability of the packaged intermediate food product of up to 8 months.

A preservative is advantageously added as well to further increase the shelf life.

For the packaging, a tube-shaped or shell-shaped container is preferably used for filling in and tightly sealing the intermediate food product with the viscous to liquid consistency. Depending on the planned use, the packaging can either be space-saving and easy to empty or such that it stands up and can be reclosed.

The object is furthermore solved with a method for the production of the intermediate food product in one of the above-mentioned forms. With this method, the dietary fiber materials and the base liquid are mixed in a first step to form a dispersion, the dispersion is then processed in a second step to form a paste-like material, the paste-like material is mixed in a third step with the remaining ingredients of the flavor base and the intermediate food product is subsequently filled in a fourth step into a packaging container, such as a tube-type or shell-type container and is securely closed, meaning sealed with respect to the environment. The handling of the intermediate food product in this way is made particularly easy and convenient. It is preferable if a homogenizer or a fast-rotating stirring, mixing, grinding or cutting device is used for the processing in the second step. Admitting the product with shearing forces preferably occurs under pre-defined conditions, for example with respect to speed or pressure. In this way, the consistency and the desired characteristics of the intermediate food product can be adjusted with particular reliability during the production of the food end product.

A further step can be used to preserve the product and additionally increase the shelf life, wherein this step even further increases the shelf life ensured by the low pH value of the intermediate food product.

Also advantageous is the use of a volumetric filler with electronic control for the filling operation during the fourth step which permits a precise and fast portioning of the intermediate food product.

It is additionally favorable if the preservation through sterilizing or pasteurizing takes place after the packaging or by adding preservatives before the packaging, thereby making it easy and convenient to improve the shelf life.

Attaching a label to the packaging in a further step is also advantageous, wherein the information relating to the ratio of intermediate food product to food end product, as well as for the processing of the intermediate food product can be applied in an easy to read form.

The following are examples of recipes for the intermediate food product, respectively the food end product produced by using the intermediate food product:

1) The intermediate food product, Example A:
40 g of a dietary fiber material, for example as described in the WO 01/17376 (such as “Herbacel AQ Plus Citrusfaser” by the company Herbstreith & Fox KG Pektin-Fabriken) and, if applicable, an additional soluble dietary fiber;
260 g water

In order to produce the intermediate food product, the dietary fiber material and the water are mixed and are sheared at high mechanical load. This is followed by filling pre-portioned amounts of the intermediate food product into tube-type packaging and by an optional reheating of same to preserve the intermediate food product.

2) The food end product in the form of a tomato sauce, Example A:

| | |
|---|---|
| 300 g | of the intermediate food product according to Point 1); |
| 790 g | water or vegetable stock; |
| 100 g | tomato paste; |
| 10 g | spices |

The water or the vegetable stock, the tomato paste and the spices are mixed with the intermediate food product and if necessary are heated up to produce the food end product.

3) The intermediate food product, Example B:
70-120 g of the dietary fiber material, for example as disclosed in the WO 01/17376 (such as “Herbacel AQ Plus Citrusfaser” by the company Herbstreith & Fox KG Pektin-Fabriken) and, if applicable, additional soluble dietary fiber materials, e.g. pectin or inulin;
785-835 g water and/or oil

| | |
|---|---|
| 15 g | salt |
| 10 g | sugar |
| 50 g | roasted vegetables |
| 20 g | meat extract |

The binding agents, for example insoluble dietary fibers or soluble dietary fibers such as pectin or inulin, are mixed with the oil and/or water, either manually or by using a mixing device, wherein initially only low shearing forces are applied. The resulting dispersion is then treated, for example, in a homogenizer or a fast-moving stirring, mixing, grinding or cutting device.

The treatment results in a paste-like material which is mixed with the remaining ingredients. The resulting intermediate food product is then filled with the aid of a volumetric filler, for example controlled electronically, into tube-type or shell-type packages.

The filled packages are subsequently additionally sterilized or pasteurized to achieve a better shelf life.

Finally, the packages are provided with labels listing the mixing ratio for the intermediate food product and are packaged further.

4) The food end product in the form of a gravy; Example B:
Part 1 the intermediate food product according to Point 3)
Parts 1-3 water and/or vegetable stock

The water or the vegetable stock is mixed with the intermediate food product and, for example, also with tomato paste and spices and is heated, if applicable, to produce the food end product.

1. An intermediate food product which is used to produce a dietary fiber-enriched food end product by mixing and further processing it with an end product admixture, wherein the intermediate food product comprises dietary fiber materials of insoluble fruit and/or vegetable fibers which are mixed with a base liquid;
characterized in that the intermediate food product is pre-portioned and packaged in a transportable packaging container, listing an amount of the end product admixture to be added in order to ensure a dietary fiber share of at least 3.0 weight % for the food end product;
and that the dietary fiber materials and the base liquid are pre-treated by admitting them with shearing forces and that these have a paste-like consistency.

2. The intermediate food product according to claim 1, characterized in that the dietary fiber materials and the base liquid are additionally mixed with a flavor base.

3. The intermediate food product according to claim 2, characterized in that the flavor base comprises salt, sugar, sweetener, seasonings, aromatic agents, vegetable components, meat extracts and/or additional soluble dietary fiber materials such as pectin or inulin.

4. The intermediate food product according to claim 1, characterized in that the starch component amounts to less than 1.5 weight %.

5. The intermediate food product according to claim 1, characterized in that the dietary fiber materials and the base liquid are heated again once they are stored in the packaging.

6. The intermediate food product according to claim 1, characterized in that a preservative is added.

7. The intermediate food product according to claim 1, characterized in that the packaging is a tube-type or shell-type container in which the intermediate food product, having a viscous to liquid consistency, is packaged tightly, so as to be sealed.

8. A method for producing an intermediate food product according to claim 1, characterized in that
in a first step, the dietary fiber materials which are composed of insoluble fruit and/or vegetable fibers and the base liquid are mixed to form a dispersion;
in a second step, the dispersion is processed with the aid of a homogenizer or a high-speed stirring, mixing, grinding and/or cutting device to form a material with a paste-type consistency;
in a third step, the paste-type material is mixed with the remaining ingredients of the flavor base; and
in a fourth step, the intermediate food product is filled into the packaging so as to be tightly sealed therein.

9. The method according to claim 8, characterized in that in an additional step the shelf life or durability of the product is ensured.

10. The method according to claim 8, characterized in that an electronically controlled volumetric filler is used for the filling operation during the fourth step.

11. The method according to claim 9, characterized in that the product is provided with a long shelf life through sterilization, pasteurizing or the addition of preservation agents.

12. The method according to claim 8, characterized in that the package is labeled in a further step.

13. The intermediate food product according to claim 3, characterized in that the starch component amounts to less than 1.5 weight %.

14. The intermediate food product according to claim 2, characterized in that the starch component amounts to less than 1.5 weight %.

15. The intermediate food product according to claim 14, characterized in that the dietary fiber materials and the base liquid are heated again once they are stored in the packaging.

16. The intermediate food product according to claim 13, characterized in that the dietary fiber materials and the base liquid are heated again once they are stored in the packaging.

17. The intermediate food product according to claim 4, characterized in that the dietary fiber materials and the base liquid are heated again once they are stored in the packaging.

18. The intermediate food product according to claim 3, characterized in that the dietary fiber materials and the base liquid are heated again once they are stored in the packaging.

19. The intermediate food product according to claim 2, characterized in that the dietary fiber materials and the base liquid are heated again once they are stored in the packaging.

20. The intermediate food product according to claim 5, characterized in that a preservative is added.
